(19) United States
(12) Patent Application Publication
(10) Pub. No.: US 2026/0339269 A1
(43) Pub. Date: Oct. 29, 2026

(54) CASE FOR A TIMEPIECE

(71) Applicant: BULGARI HORLOGERIE SA, Neuchâtel (CH)

(72) Inventors: Thomas Maurice, Cortaillod (CH); Nicolas Stoudmann, Cugy (CH); Xavier Greppin, Crissier (CH)

(73) Assignee: BULGARI HORLOGERIE SA, Neuchâtel (CH)

(21) Appl. No.: 19/107,874

(22) PCT Filed: Aug. 29, 2023
(86) PCT No.: PCT/EP2023/073724

§ 371 Date: Feb. 28, 2025

(30) Foreign Application Priority Data
Aug. 29, 2022 (FR) FR2208641

(51) Int. Cl. G04B 27/00; G04D 7/00

(52) U.S. Cl. CPC G04B 27/007; G04D 7/004

(57) ABSTRACT

The device for setting the time of the timepiece 100) has at least one hand (101) movable about a first axis (A1) to indicate time, a manipulable time-setting member (103), a sensor assembly (2) for detecting one or more discrete positions of at least one hand (1), an element (3) for determining the current time, in particular a reference clock (3), an actuator (4) for actuating a manipulable time-setting member (103), and a processing logic unit (5) capable of controlling the actuator (4) according to data received from the sensor assembly (2) and the element (3) for determining the current time. The device also has a casing (6) and a movable portion (7) rotatably movable about a second axis (A2) relative to the casing (6), with a masking element (74), opaque to visible light and transparent to radiation detected by the sensor assembly (2).

### TECHNICAL FIELD OF THE INVENTION

The invention concerns a device for setting the time for a timepiece. The invention also concerns a method for setting the time, or a method for operation of a device of this type.

### BACKGROUND ART

Cases for timepieces have two main functions, i.e. those of storing a timepiece, and of presenting this timepiece.

After a prolonged period of storage in a case (beyond its autonomy), a timepiece stops, and no longer indicates the current or desired time. The user must therefore correct the time of the timepiece when he wishes to use it once again.

It is known to propose cases designed for automatic watches which provide a solution to this problem. These cases propose means for retention of the timepieces which are rotated in the case. Consequently, the timepieces stored are also those which are rotated around a non-vertical axis. This gives rise to a movement of an oscillating mass of a timepiece stored relative to the casing of the movement of the timepiece, and consequently to winding of the timepiece.

However, even with a case of this type, an automatic watch can indicate a time which is very erroneous after lengthy period of storage in the case, as a result of a running error of the timepiece. In this situation, the user must therefore also correct the time of the timepiece when he wishes to use it once more.

### SUMMARY OF THE INVENTION

The objective of the invention is to provide a device for setting the time and a method for setting the time which eliminate the aforementioned disadvantages, and improve the cases known in the prior art. In particular, the invention proposes a device for setting the time which makes it possible to facilitate the setting the time of a timepiece.

According to a first aspect of the invention, a device is defined by point 1 below.
1. A device for setting the time for a timepiece, in particular a watch, in particular a wristwatch, provided with:
   at least one hand which is movable around a first axis in order to indicate the time; and
   a manipulable unit for setting the time, the device comprising:
   a sensor assembly for detection of one or a plurality of discrete positions of at least one hand;
   an element for determination of a current time, in particular a reference clock;
   an actuator in order to actuate a manipulable unit for setting the time; and
   a processing logic unit which is suitable, or configured to, control the actuator according to data received from the sensor assembly and the element for determination of a current time,
the device comprising a casing and a movable part, which in particular is movable in rotation around a second axis relative to the casing, between a first position and a second position, the movable part comprising a masking element, in particular a window, which is opaque to visible light and transparent to the radiation detected by the sensor assembly.

Different embodiments of the device are defined by points 2 to 10 below.
2. The device as defined in point 1, wherein the sensor assembly comprises a plurality of sensors, the sensors:
   being of an optical nature, in particular being infrared sensors; and/or
   each comprising a signal emitter and a receiver for a reflected signal; and/or
   being distance or proximity sensors; and/or
   being arranged and/or configured such as to be positioned around the first axis, in particular positioned according to a regular angular distribution around the first axis.
3. The device as defined in one of the preceding points, wherein the casing comprises a receptacle for receipt and positioning of a timepiece on the casing, and wherein the sensor assembly is arranged on the movable part.
4. The device as defined in the preceding point, wherein the casing comprises first positioning elements, and wherein the movable part comprises second positioning elements, the first and second positioning elements being able to position the sensor assembly relative to the receptacle.
5. The device as defined in one of the preceding points, wherein the device is a presentation box or a case, the casing being for example a case base, and the movable part being for example a case cover.
6. The device as defined in one of the preceding points, wherein it comprises a sensor for detection of the position of the movable part relative to the casing.
7. The device as defined in one of the preceding points, wherein the device comprises a battery.
8. The device as defined in one of the preceding points, wherein the reference clock is a quartz oscillator clock, the quartz oscillator being for example a quartz oscillator with temperature compensation.
9. The device as defined in one of the preceding points, wherein the device comprises a man-machine interface provided with one or more sources of light indicating according to their state the operating state of the device.
10. The device as defined in the preceding point and in point 5, wherein the base comprises a lower face and feet projecting relative to the lower face, the source(s) of light being arranged on the lower face.

According to the first aspect of the invention, a method is defined by point below.
11. A method for setting the time of a timepiece provided with:
   at least one hand which is movable around a first axis in order to indicate the time; and
   a manipulable unit for setting the time,
or a method for operation of a device as defined in one of the preceding points, the method comprising a phase of setting the time comprising the following steps:
   actuating a chain of correction of the timepiece by means of an actuator;
   detecting at least one passage of the at least one hand in front of a sensor assembly;
   deducing from this detection a time displayed by the timepiece;
   determining the current time, in particular reading the current time indicated by a reference clock;
   defining an amplitude of actuation of the chain of correction of the timepiece, such that the at least one hand indicates the current time;
   actuating the chain of correction of the timepiece from this amplitude by means of the actuator, via actuation of the manipulable unit for setting the time.

Different embodiments of the method are defined by points 12 to 14 below.
12. The method as defined in the preceding point, wherein the phase of setting the time is launched:
   automatically, for example at a given time; and/or
   after a specific action by a user.
13.The method as defined in the preceding point, wherein the phase of setting the time is launched only if the movable part is in a given position relative to the casing, in particular if the cover of the case is closed.
14.The method as defined in one of points 11 to 13, wherein the phase of setting the time comprises control of emission of a signal, in particular switching on of one or more sources of light indicating that the phase of setting the time is in progress.

According to a second aspect, the invention is defined by the following proposals:
1. Device (1) for setting the time for a timepiece (100), in particular a watch, in particular a wristwatch, provided with:
   at least one hand (101) which is movable around a first axis (A1) in order to indicate the time; and
   a manipulable unit (103) for setting the time,
the device comprising:
   a sensor assembly (2) for detection of one or a plurality of discrete positions of at least one hand (1);
   an element (3) for determination of a current time, in particular a reference clock (3);
   an actuator (4) in order to actuate a manipulable unit (103) for setting the time; and
   a processing logic unit (5) which is suitable or configured to control the actuator (4) according to data received from the sensor assembly (2) and the element (3) for determination of a current time.
2. The device according to proposal 1, wherein the sensor assembly comprises a plurality of sensors (21), the sensors:
   being of an optical nature, in particular being infrared sensors; and/or
   each comprising a signal emitter and a reflected signal receiver; and/or
   being distance or proximity sensors; and/or
   being arranged and/or configured such as to be positioned around the first axis (A1), in particular positioned according to a regular angular distribution around the first axis (A1).
3. The device according to one of the preceding proposals, wherein the device comprises a casing (6) and a movable part (7), which in particular is movable in rotation around a second axis (A2) relative to the casing (6), between a first position and a second position.
4. The device according to the preceding proposal, wherein the casing (6) comprises a receptacle (61) for receipt and positioning of a timepiece (100) on the casing, and wherein the sensor assembly (2) is arranged on the movable part (7).
5. The device according to the preceding proposal, wherein the casing (6) comprises first positioning elements (62, 63), and wherein the movable part (7) comprises second positioning elements (72, 73), the first and second positioning elements being able to position the sensor assembly (2) relative to the receptacle (61).
6. The device according to one of proposals 3 to 5, wherein the movable part (7) comprises a masking element (74), in particular a window, which is opaque to visible light and transparent to the radiation detected by the sensor assembly (2).
7. The device according to one of proposals 3 to 6, wherein the device is a presentation box or a case, the casing (6) being for example a case base, and the movable part (7) being for example a case cover.
8. The device according to one of proposals 3 to 7, wherein it comprises a sensor (11) for detection of the position of the movable part (7) relative to the casing (6).
9. The device according to one of the preceding proposals, wherein the device comprises a battery (8).
10. The device according one of the preceding proposals, wherein the reference clock (3) is a quartz oscillator clock, the quartz oscillator being for example a quartz oscillator with temperature compensation.
11. The device according to one of the preceding proposals, wherein the device comprises a man-machine interface (10) provided with one or more sources of light (109) indicating according to their state the operating state of the device.
12. The device according to the preceding proposal and according to proposal 7, wherein the base comprises a lower face (64) and feet (65) projecting relative to the lower face (64), the source(s) of light being arranged on the lower face.
13. A method for setting the time of a timepiece (100) provided with:
   at least one hand (101) which is movable around a first axis (A1) in order to indicate the time; and
   a manipulable unit (103) for setting the time,
or a method for operation of the device according to one of the preceding proposals, the method comprising a phase of setting the time comprising the following steps:
   actuating a chain of correction of the timepiece (100) by means of an actuator (4);
   detecting at least one passage of the at least one hand (101) in front of a sensor assembly (2);
   deducing from this detection a time displayed by the timepiece;
   determining the current time, in particular reading the current time indicated by a reference clock (3);
   defining an amplitude of actuation of the chain of correction of the timepiece (100), such that the at least one hand indicates the current time;
   actuating the chain of correction of the timepiece (100) from this amplitude by means of the actuator (4), via actuation of the manipulable unit (103) for setting the time.
14. The method according to the preceding proposal, wherein the phase of setting the time is launched:
   automatically, for example at a given time; and/or
   after a specific action by a user.
15. The method according to the preceding proposal, wherein the phase of setting the time is launched only if the movable part (7) is in a given position relative to the casing (6), in particular if the cover (7) of the case is closed.
16. The method according to one of proposals 13 to 15, wherein the phase of setting the time comprises control of emission of a signal, in particular switching on of one or more sources of light (109) indicating that the phase of setting the time is in progress.

### BRIEF DESCRIPTION OF THE DRAWINGS

The objectives, characteristics and advantages of the present invention are described in detail in the following description of a particular embodiment, provided by way of non-limiting example in relation with the appended figures.

FIG. 1 is a view in perspective of an embodiment of a device for setting the time according to the invention.

FIG. 2 is a schematic view of the embodiment of the device for setting the time.

FIG. 3 is a schematic view illustrating a step of implementation of a mode of execution of the method for setting the time according to the invention.

FIG. 4 is a schematic view illustrating another step of implementation of the mode of execution of the method for setting the time according to the invention.

FIG. 5 is a schematic view of a signal produced by a sensor during passage of a hand in front of the sensor.

### DETAILED DESCRIPTION OF PARTICULAR EMBODIMENTS

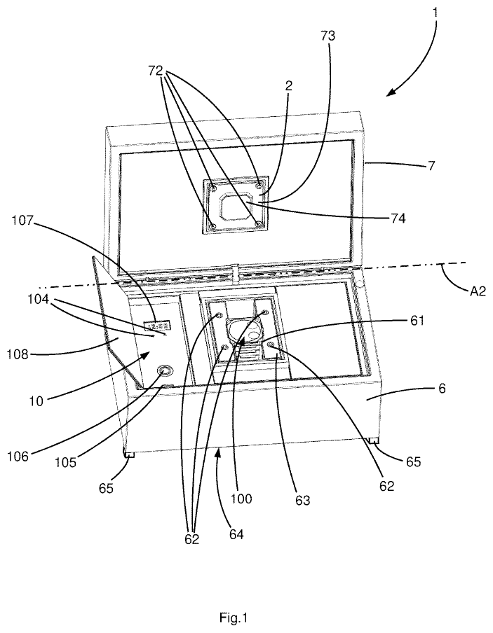

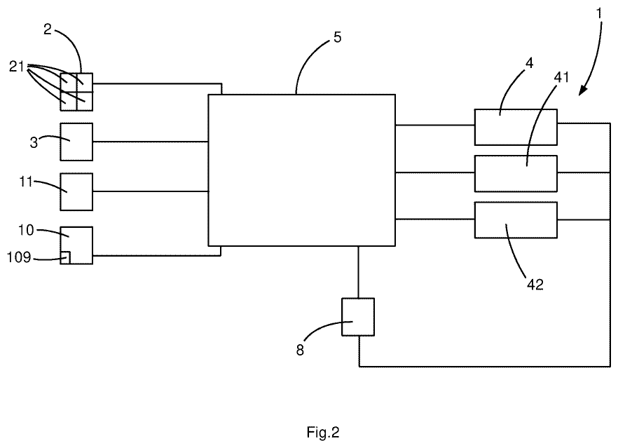

An embodiment of a device 1 for setting the time for a timepiece 100 is described hereinafter in detail with reference to FIGS. 1 and 2.

The device 1 for setting the time can be used to carry out automatic setting of the time of any type of watch 100 with:
at least one hand 101 which is movable around a first axis A1 in order to indicate a current time, in particular by cooperation with a dial 102; and
a manipulable unit 103 for setting the time, i.e. a unit which can be manipulated by a user in order to correct the time indicated by the hands by modifying the position of the hands.

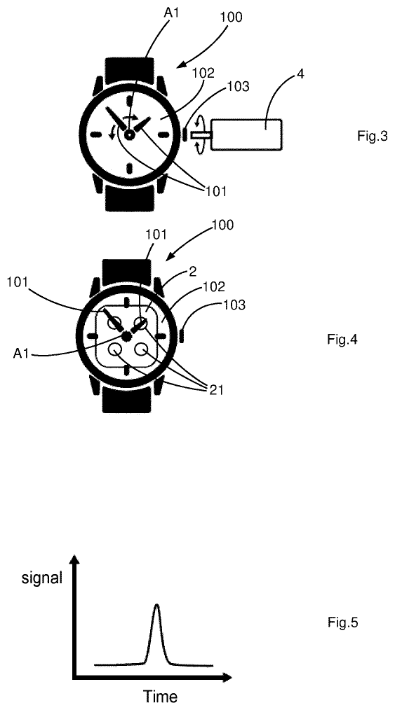

For example, in FIGS. 3 and 4, the timepiece 100 represented is a wristwatch comprising two hands 101 (an hours hand and a minutes hand) and a dial 102.

For example, in FIG. 1, the timepiece represented is a wristwatch comprising a display of a regulator type, i.e. two hands which each turn around different axes, and for example each cooperate with different dials.

For example, the manipulable unit can be:
a crown fitted on a rod; or
a wheel; or
a knurling roller.

The manipulable unit is connected permanently or via a coupling to a kinematic correction chain, such that displacement of the manipulable unit gives rise to displacement of the hands. In addition, the transmission ratio of the correction chain is known, such that the displacement of the hands induced by a given displacement of the manipulable unit is known.

The device for setting the time is particularly advantageous for mechanical timepieces (such as watches and wristwatches) (whether they are automatic or not) because of the aforementioned problems.

The device 1 for setting the time for a timepiece 100 comprises:
a sensor assembly 2, for detection of one or more discrete positions of at least one hand 1;
an element 3 for determination of a current time, in particular a reference clock 3;
an actuator 4 for actuation of a manipulable unit 103 for setting the time; and
a processing logic unit 5 which can, or is configured to, control the actuator 4 according to data received from the sensor assembly 2 and from the element for determination of the time.

The sensor assembly 2 preferably comprises a plurality of sensors 21. for example, the sensors:
are optical sensors, in particular infrared sensors; and/or
each comprise a signal emitter and a receiver for a reflected signal; and/or
are distance or proximity sensors; and/or
are designed and/or configured such as to be positioned around the first axis A1, in particular positioned according to a regular angular distribution around the first axis A1. A distribution of this type is for example represented in FIG. 4, in which the sensors are represented positioned facing the timepiece at directions forming angles at 45° with the directions 3 h, 6 h, 9 h and 12 h of the timepiece. In FIG. 4, the hours hand is represented facing a first sensor, and the minutes hand is represented facing a second sensor.

The use of a plurality of sensors makes it possible to compensate for any mechanical positioning error of the sensors relative to the timepiece. These errors can be caused by different parameters, such as, for example:
welding of the sensor on an electronic board;
securing of the electronic board on the remainder of the device;
positioning of the movable part 7 on the casing 6; and
positioning of the timepiece in the receptacle designed to receive it.

The reference clock 3 is for example a quartz oscillator clock. Also preferably, the quartz oscillator is for example a quartz oscillator with temperature compensation. Consequently, the reference clock can give an indication of the current time with great accuracy. The reference clock can be of another type, or it can have other characteristics. The clock can be radio-controlled. In particular, the clock can be updated on the basis of information sent by a satellite of a geo-localization system. The clock can also be on the exterior of the device for setting the time.

The actuator 4 is for example a gear motor comprise a step-by-step motor and a reducer, such as to be able to control precisely the displacement of the manipulable unit 103 for setting the time, and thus the displacement of the hands 101. The actuator also comprises a unit for coupling to the manipulable unit 103 for setting the time. This coupling unit can comprise a gripper which is designed to seize the manipulable unit 103 for setting the time, such as to apply to it movements of rotation, or also movements of translation, optionally in order to carry out a change of regulation mode of the timepiece. According to another embodiment, the manipulable unit 103 for setting the time can comprise toothing, which is designed to cooperate by engagement with another set of toothing arranged on the coupling unit. The coupling unit can thus be movable between a position of engagement of the two sets of toothing, and a position of non-engagement of the two sets of toothing. According to yet another embodiment, the manipulable unit 103 for setting the time can comprise a friction surface, which is designed to cooperate by friction with another friction surface arranged on the coupling unit. The coupling unit can thus be movable between a position of cooperation of the two sets of toothing, and a position of non-cooperation of the two sets of toothing.

The processing logic unit 5 comprises for example a microprocessor.

As represented in FIG. 1, the device advantageously comprises a casing 6 and a movable part 7. The casing 6 and the movable part 7 are fitted such as to be movable in rotation relative to one another around a second axis A2, between a first position (represented in FIG. 1) and a second position (not represented).

The casing 6 comprises a receptacle 61 for receipt and positioning of the timepiece 100 on the casing. In addition, the sensor assembly 2 is arranged on the movable part 7. The receptacle 61 preferably has dimensions such as to receive a housing where the middle of the timepiece has less play. Also preferably, means for flanging of the timepiece can be provided, in order to place the timepiece, in particular the housing of the timepiece, in the receptacle 61. Less play makes it possible to ensure good coupling cooperation of the actuator 4 and the manipulable unit 103 for setting the time, with the actuator being fitted on the casing 6. The flanging means can be activated and/or deactivated by means of an actuator 41.

Also advantageously:
the casing 6 comprises first positioning elements 62, 63; and
the movable part 7 comprises second positioning elements 72, 73, the first and second positioning elements being able to position the sensor assembly 2 relative to the receptacle 61.

The positioning element 72 can be studs or pins cooperating with bores 62. The cooperation of the positioning elements makes it possible to position the movable part 7 relative to the casing 6 on a plane (in particular a plane parallel to the planes of rotation of the hands). The means can be inverted, and the studs can be located on the casing 6, whereas the bores are positioned on the movable part 7.

The positioning elements also advantageously comprise two support elements 63 and 73, which cooperate in order to provide a flat support, and to position the casing 6 and the movable part accordingly relative to one another, perpendicularly to the aforementioned plane. This makes it possible to position the sensor assembly 2 precisely relative to the timepiece 100, and in particular relative to the at least one hand.

These different positioning elements cooperate when the movable part 7 is in its second position (folded back, represented schematically in FIG. 4) on the casing 6.

The movable part 7 and the casing 6 are arranged such as to ensure good and complete cooperation of the different positioning elements in the second position. This makes it possible to guarantee very accurate positioning of the timepiece 100 relative to the sensor assembly 2, for example positioning with a linear positioning tolerance of less than 0.4 mm or less than 0.2 mm in all directions, and an angular positioning tolerance of less than 0.5°, or less than 0.3° in all directions.

Preferably, certain positioning elements, or all the positioning elements 62, 63, 72, 73 are situated at less than 1 cm or at less than 2 cm from the timepiece 100 in the second position of the movable part 7.

Preferably, the movable part 7 comprises a masking element 74, in particular a window, which is opaque to visible light, and transparent to the radiation detected by the sensor assembly 2. This makes it possible to improve the finishing of the device, by masking the electronic components such as the sensors 21 of the sensor assembly 2.

Preferably, the device 1 is a presentation box or a case. The casing 6 is for example a case base, and the movable part 7 is for example a case cover.

In addition, the device 1 can advantageously comprise a sensor 11 for detection of the position of the movable part 7 relative to the casing 6. Preferably, the sensor makes it possible to determine whether the movable part 7 is in the second position relative to the casing 7 or not.

As represented in FIG. 2, the device 1 can also comprise any combination of one or more of the following elements:
an electrical energy storage battery 8;
a man-machine interface 10;
an actuator for winding of the timepiece.

Preferably, the battery 8 allows the device 1 to be autonomous, and makes it possible to supply power to all of the elements of the device 1 which need electrical energy for their operation.

The winding actuator 42 can be different from the actuator 4 for setting the time, if the units of the timepiece for setting the time and the winding are different.

The man-machine interface 10 is for example positioned in the casing 6, in particular adjacent to the receptacle 61 for receipt of the timepiece 100. Advantageously, the casing or the base 6 comprises a shutter 108, which is designed to cover the man-machine interface 10, in order to mask it. For example, the shutter is articulated on the remainder of the casing 6.

The man-machine interface 10 can comprise any combination of one or more of the following elements:
a display screen 107, in particular a screen for display of the current time indicated by the reference clock 3;
one or more control buttons 106, which make it possible in particular to control the launching of a method for operation of the device 1, making it possible to set the time of the timepiece 100 automatically;
a socket 105, in particular a female USB socket, making it possible to recharge the battery 8 with an exterior source of energy;
one or more regulation buttons 104, making it possible in particular to regulate the current time provided by the reference clock 3;
one or more sources of light 109, indicating according to their state the operating state of the device.

Advantageously, the base 6 comprises a lower face 64 and feet 65 projecting relative to the lower face 64. The source(s) of light is/are arranged on the lower face. Thus, the feet 65 provide a space between the lower face and the surface on which the device 1 is supported. Consequently, when one or more source(s) of light is/are lit, it they produce backlighting visible by the user by reflection of the rays of light on the surface. Each source of light can be a light-emitting diode.

The device 1 for setting the time, in particular the processing logic unit 5, comprises all the hardware and/or software means necessary to control its operation, and to implement the method which is the subject of the invention, and in particular the method described hereinafter.

The means mentioned can comprise software modules.

A mode of execution of a method for setting the time of a timepiece 100 is described in detail hereinafter. This method can also be perceived as a method for operation of the device for setting the time previously described.

In a first step a user puts the timepiece 100 into place in the receptacle 61.

In a second step, the user commands launching of a phase of setting the time, for example by acting on a control button 106.

In a third step, the user positions the movable part 7 in its second position relative to the casing 6. This second position is detected by the sensor 11, and launching of the phase of setting the time (comprising the following fourth to ninth steps) then begins.

In a fourth step, the device 1 couples the actuator 4 to the manipulable unit 103 for setting the time, and actuates a chain of correction of setting the time of the timepiece 100, by putting the manipulable unit 103 for setting the time into motion by means of the actuator 4. A step of this type is illustrated by FIG. 3.

In a fifth step, the device 1 detects at least one passage of the at least one hand 101 in front of the sensor assembly 2. This passage gives rise to temporal variation of the signal emitted by a sensor, as illustrated by FIG. 5. At the extremum, the hand is facing the sensor. It should be noted that the form of the signal produced during passage of a hand in front of a sensor depends on a plurality of parameters, including in particular any combination of one or more of the following parameters:
the speed of rotation of the hand;
the geometry of the hand, in particular its width;
the location of the hand in a direction perpendicular to the dial 102;
the optical appearance of the hand, in particular its color and/or its surface state.

Thus, with these different parameters of influence, by analyzing the signals of the sensors, the device 1 can distinguish a passage of an hours hand from the passage of a minutes hand. The passage of other hands can also be detected and distinguished.

After a plurality of detections of passages of one or more hands in front of the sensors, in a sixth step the device 1 analyzes signals of the sensors, and deduces therefrom the time displayed by the timepiece during the final detection of passage of a hand in front of a sensor.

In a seventh step, the device 1 determines the current time, in particular by reading the current time indicated by the reference clock 3.

In an eighth step, the device 1 defines by calculation an amplitude of actuation of the chain of correction of the timepiece 100, such that the at least one hand indicates the current time. For this purpose, the device 1 uses the current time previously determined and the time displayed by the timepiece during the final detection of passage of a hand in front of a sensor.

In a ninth step, the device 1 actuates the chain of correction of the timepiece 100 for this amplitude by means of the actuator 4, via actuation of the manipulable unit 103 for setting the time. For this purpose, the device uses the knowledge:
of the transmission ratio of the correction chain of the timepiece between the manipulable unit 103 for setting the time and the hands; and
of the transmission ratio between the motor and the exit of the actuator.

The timepiece is thus correctly set. The phase of setting the time has been completed.

In a tenth step, the user can displace the movable part to its first position, and remove the timepiece from the movement.

Contrary to what has been described in detail, the phase of setting the time can alternatively be implemented automatically, for example at regular intervals, for example at a given time each day or each week, if the timepiece is in place in the device 1.

Also preferably, the phase of setting the time is started only if the movable part 7 is in its second position relative to the casing 6, in particular if the cover 7 of the case is closed.

Also preferably, the phase of setting the time comprises control of emission of signal, in particular switching on of one or more sources of light 109, indicating to the user that the phase of setting the time is in progress.

The method can also comprise a phase of winding of the timepiece 100, in particular by activating:
a winding actuator 42 dedicated to the winding, if the units of the timepiece for setting the time and winding are different; or
the actuator 4, after having configured the manipulable unit 103 in a position which permits the winding.

This winding phase can be implemented:
before the phase of setting the time, in particular between the third and fourth steps previously described; or
after the phase of setting the time.

1. A device for setting the time for a timepiece, comprising:
at least one hand which is movable around a first axis in order to indicate a time; and
a manipulable unit for setting the time,
a sensor assembly for detection of one or a plurality of discrete positions of at least one hand;
an element for determination of a current time;
an actuator adapted to actuate a manipulable unit for setting the time; and
a processing logic unit adapted to control the actuator according to data received from the sensor assembly and the element for determination of a current time,
a casing, and,
a movable part, the movable part comprising a masking element which is opaque to visible light and transparent to radiation detected by the sensor assembly.

2. The device as claimed in claim 1, wherein the sensor assembly comprises a plurality of sensors, the sensors:
being of an optical nature; and/or
each comprising a signal emitter and a receiver for a reflected signal; and/or
being distance or proximity sensors; and/or
being positioned around the first axis.

3. The device as claimed in claim 1, wherein the casing comprises a receptacle for receipt and positioning of a timepiece on the casing, and wherein the sensor assembly is arranged on the movable part.

4. The device as claimed in claim 3, wherein the casing comprises first positioning elements, and wherein the movable part comprises second positioning elements, the first and second positioning elements being able to position the sensor assembly relative to the receptacle.

5. The device as claimed in claim 1, wherein the device is a presentation box or a case.

6. The device as claimed in claim 1, wherein the device comprises a sensor for detection of a position of the movable part relative to the casing.

7. The device as claimed in claim 1, wherein the device comprises a battery.

8. The device as claimed in claim 1, wherein the reference clock is a quartz oscillator clock.

9. The device as claimed in claim 1, wherein the device comprises a man-machine interface provided with one or more sources of light indicating an operating state of the device according to a state of the one or more sources of light.

10. The device as claimed in claim 9, wherein the device is a presentation box or a case, the casing being a case base, and wherein the case base comprises a lower face and feet projecting relative to the lower face, the one or more sources of light being arranged on the lower face.

11. A method for operation of the device as claimed in claim 1, the method comprising a phase of setting the time comprising:
actuating a chain of correction of the timepiece using an actuator;
detecting at least one passage of the at least one hand in front of a sensor assembly;
deducing, from the detecting, a time displayed by the timepiece;
determining a current time;
defining an amplitude of actuation of the chain of correction of the timepiece;
actuating the chain of correction of the timepiece from the amplitude using the actuator by actuating the manipulable unit for setting the time.

12. The method as claimed in claim 11, wherein the phase of setting the time is launched:
automatically; and/or
after a specific action by a user.

13. The method as claimed in claim 12, wherein the phase of setting the time is launched only if the movable part is in a given position relative to the casing.

14. The method as claimed in claim 11, wherein the phase of setting the time comprises controlling emission of a signal.

15. The method as claimed in claim 14, wherein the phase of setting the time comprises controlling switching on of one or more sources of light indicating that the phase of setting the time is in progress.

16. The method as claimed in claim 13, wherein the phase of setting the time is launched only if a cover of the case is closed.

17. The device as claimed in claim 1, wherein the element for determination of a current time is a reference clock.

18. The device as claimed in claim 1, wherein the movable part is movable in rotation around a second axis relative to the casing between a first position and a second position.

19. The device as claimed in claim 1, wherein the masking element is a window.

20. The device as claimed in claim 2, wherein the sensors are positioned according to a regular angular distribution around the first axis.
